(19) United States
(12) Patent Application Publication
(10) Pub. No.: US 2007/0241563 A1
(43) Pub. Date: Oct. 18, 2007

(54) Universal nipple for wall-mountable structures

(75) Inventors: Kipley Roydon Marks, Auckland (NZ); Walter Pitsch, Washington, NJ (US)

Correspondence Address: BENJAMIN LA BORDE, 204 ESPLANADE, IRVINE, CA, 92612-1713, US

(73) Assignee: American Standard International Inc

(21) Appl. No.: 11/403,088

(22) Filed: Apr. 12, 2006

(51) Int. Cl. F16L 15/00

(52) U.S. Cl. 285/390

(57) ABSTRACT

A universal nipple for securement of a wall-mountable structure to a mounting surface is provided. The nipple includes a shank having an elongate body of predefined length that terminates in opposed proximate and distal ends. The proximate end has an enlarged head portion through which an opening is defined, and the distal end has engagement means defined thereat for engagement with the mounting surface. The body has a generally circumferential outer surface and an inner surface defining a tapering lumen that is coextensive with the proximate and distal ends. The engagement means comprises at least one, and preferably plural, series of threads defined along the outer circumferential surface with grooves distributed intermittently therebetween. The body is easily truncated along a selective groove so as to accommodate mounting surfaces of varying thicknesses and establish fluid communication between a wall-mountable fluid delivery device and plumbing structure provided at or adjacent the mounting surface.

### FIELD OF THE INVENTION

The present invention is directed to a universal nipple for water delivery devices (such as showerheads, bath spouts and the like) and bathroom accessories (including but not limited to mirrors, shelves, towel bars, toilet tissue holders, tumbler holders and the like). More particularly, the present invention is directed to a universal fluid communication nipple that secures a plurality of wall-mounted water delivery devices to plumbing structure that is fixed behind a wall surface. The universal nipple of the present invention includes a shank of uniform diameter having a series of threads circumferentially disposed thereon at spaced intervals. This configuration accommodates varying installation depths required by different types of devices and accessories, thereby reducing the requisite time and cost for installation of wall mountable structures.

### BACKGROUND OF THE INVENTION

Common wall-mounted water delivery devices, such as showers and bath spouts, necessarily require fluid communication with a plumbing structure located behind the wall surface (hereinafter “behind-the-wall plumbing”). Mounting members for such devices must achieve fluid communication while sustaining the considerable weight of such water delivery devices and the large multi-directional forces inherently borne thereby. In addition, mere functionality is insufficient to accommodate the desired aesthetic effect of such devices. It is not uncommon, therefore, for such mounting members to conceal the member's support structure (i.e., via commonly used fasteners such as screws, washers, springs and the like).

Conventional mounting members, however, lack versatility with respect to water devices of varying shape and function. Multiple fasteners of varying dimension are often required to achieve watertight connection between the water delivery device and behind-the-wall plumbing. If more than one such device is mounted as part of a suite of sanitary fittings, multiple fasteners and corresponding support structures are required to fulfill the functional and aesthetic requirements of wall mounting. Thus, in spite of variances in weight, multi-directional forces and mounting distances between the wall surface and the behind-the-wall plumbing, the installer must always consider the individual characteristics of each device and ensure a watertight seal at various installation depths.

There are a plurality of available devices for securement of a wall-mountable device (see for example U.S. Pat. No. 5,026,013 to Robbins which discloses a support post mounting assembly having a bracket with first and second aperture sections and a jamb nut with internal threads; U.S. Patent Application No. 2002/0023993 to Fleischmann et al. which discloses a wall-mountable accessory assembly having a bracket with an axial extension, a plate and an elongate escutcheon for receipt of the bracket extension therein; U.S. Pat. No. 6,520,463 to Ouano which discloses a mounting bracket for a wall-mounted accessory having a bracket with multiple flanges that engage an accessory post having a base with a cavity for receipt of the bracket thereby). There are also multiple commercially available devices for securing water delivery devices to a wall that are well known in the art. Heretofore, however, there are no devices that combine the functionality of accessory fasteners and water delivery connectors to ease the installation of such accessories and water delivery devices.

It is therefore desirable to provide a universal fluid connection and mounting device that facilitates relatively fast and accurate mounting of water delivery devices, bathroom accessories and similar structures. Such a device ensures watertight connections at a plurality of mounting thicknesses and desirably exhibits a simple structure for inexpensive manufacture.

### SUMMARY OF THE INVENTION

It is an advantage of the present invention to provide a device that accommodates proper mounting of wall-mountable structures and water delivery devices.

It is another advantage of the present invention to customize such a device for proper securement in support structures of varying mounting thicknesses.

It is another advantage of the present invention to provide such a device that remains hidden from view to promote an aesthetically desirable appearance.

It is a further advantage of the present invention to provide an economical device that accommodates unimpeded fluid flow therethrough when used in cooperation with a water delivery device and simultaneously supports the weight of such device without compromise. Such a device also successfully supports the weight of at least one of a plurality of wall-mountable accessories of varying weights and configurations.

In the attainment of these and other advantages, the present invention provides a universal nipple for securement of a wall-mountable structure to a mounting surface. The universal nipple of the present invention comprises a shank having an elongate body of predefined length. The body terminates in a proximate end and an opposed distal end, with the proximate end having an enlarged head portion from which the body depends generally normally. The distal end includes means defined thereat for engagement with the mounting surface. The body assumes a generally cylindrical configuration with a circumferential outer surface and an inner surface defining a lumen that is coextensive with the proximate and distal ends. The head desirably includes an open area therethrough that establishes communication with the lumen. The circumferential outer surface and the inner surface together define a predefined body thickness therebetween. The engagement means comprises at least one, and desirably plural, series of threads defined along the outer circumferential surface. Grooves are intermittently disposed between each thread series and may accommodate one or more corresponding seals thereat.

The lumen may have a tapering configuration wherein the lumen has a first diameter at the proximate end and a second smaller diameter at the distal end. The extent of the taper does not affect the unobstructed flow of fluid through the lumen.

The present invention also provides a system for effecting securement of a wall-mountable structure to a mounting surface. The system includes a wall-mountable device and a universal nipple as described hereinabove. The nipple's threads engage corresponding engagement means provided on preinstalled support structure located at or adjacent the mounting surface. Such engagement establishes communication between the wall-mountable structure and the support structure. The wall-mountable device of the present invention system may be a water delivery device selected from the group of water delivery devices including, but not limited to, showers, bath fillers, faucets and combinations thereof. Engagement between the inventive nipple and such water delivery devices easily establishes fluid communication between the water delivery device and preinstalled plumbing structure at or adjacent the support structure. Such fluid communication is established in combination with effective support of the water delivery device, regardless of the support structure thickness or the distance of the support structure from the plumbing structure.

In use, the present invention accommodates a plurality of accessories and water delivery device configurations, and successfully sustains such products in support structures of varying thicknesses. This is because the nipple body may be selectively truncated at a selected groove so as to remove a predetermined number of thread series and/or the head portion. The nipple is therefore easily modified for a plurality of installation configurations without detracting from the nipple's inherent benefits.

Various other advantages and features of the present invention will become readily apparent from the ensuing detailed description.

### BRIEF DESCRIPTION OF THE DRAWINGS

FIG. 1 shows a side view of a universal nipple of the present invention.

FIG. 2 shows a cross-section of the universal nipple of FIG. 1 taken along longitudinal axis a thereof.

FIG. 3 shows a top view of the universal nipple of the present invention as viewed from a head portion thereof.

FIG. 4 shows a partial sectional view of a universal nipple of the present invention secured in a wall and connected to an elbow pipe therebehind.

FIG. 5 shows a partial sectional view of the assembly of FIG. 4 in combination with a'shower fitting.

FIG. 6 shows a partial sectional view of the combination of FIG. 5 at a different installation depth.

### DESCRIPTION OF THE INVENTION

It is an advantage of the present invention to provide a universal nipple that yields a sturdy support for a water delivery device, bathroom accessory or other wall-mountable structure. The present invention provides a universal nipple that remains hidden from view and thereby produces an aesthetically desirable appearance. The universal nipple of the present invention does not incorporate specialized parts that undesirably increase the cost, time and complexity of manufacture of the device and/or installation of the wall-mountable structure.

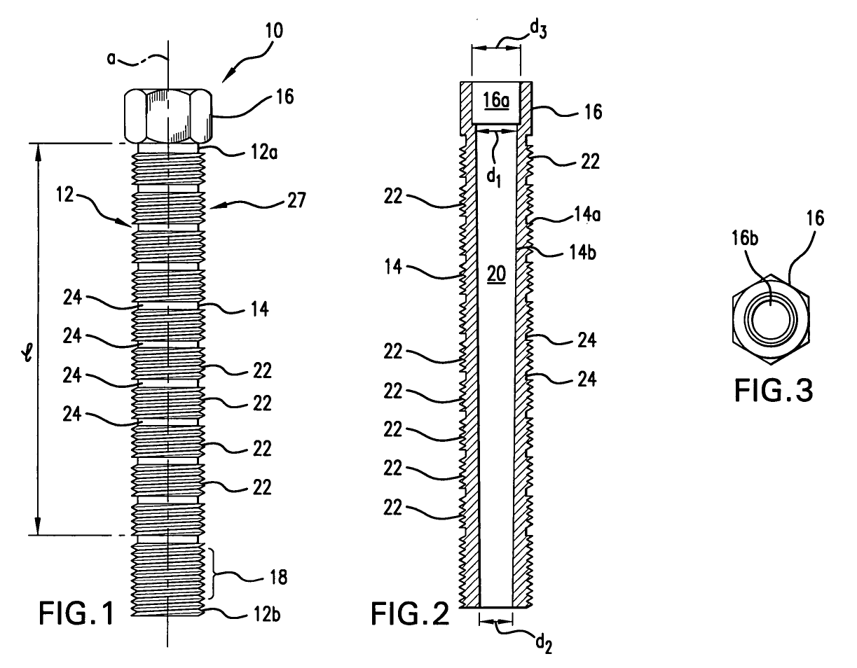

Now referring to FIGS. 1 to 3, wherein like numbers identify like elements, the universal nipple 10 of the present invention includes an elongate shank 12 having a body 14 that extends along length l and a longitudinal axis 4 defined therethrough. Shank 12 includes a proximate end 12a at which shank 12 depends generally normally from a head portion 16 (which head portion may assume the geometry of a hexagonal nut as shown in FIG. 3 or any other geometry amenable to operation of the universal nipple) and a distal end 12b having a series of threads 18 thereat to accommodate insertion of shank 12 into a mounting surface.

Body 14 has a generally circumferential outer surface 14a and a tapering inner surface 14b that defines a tapering lumen 20 thereby through which fluid flows unobstructed. As shown, lumen 20 has a first diameter d₁ at proximate end 12a of shank 12 and gradually tapers to a second smaller diameter d₂ at distal end 12b. Along outer surface 14a, plural thread series 22 are disposed intermittently with grooves 24. Head portion 16 also has an open area 16a therewithin, shown as circumferential opening 16b having diameter d₃ (although it is understood that neither head portion 16 nor open area 16a defined therewithin is limited to such geometry). It is understood that lumen 20 may have uniform diameter along its entire length or any portion thereof.

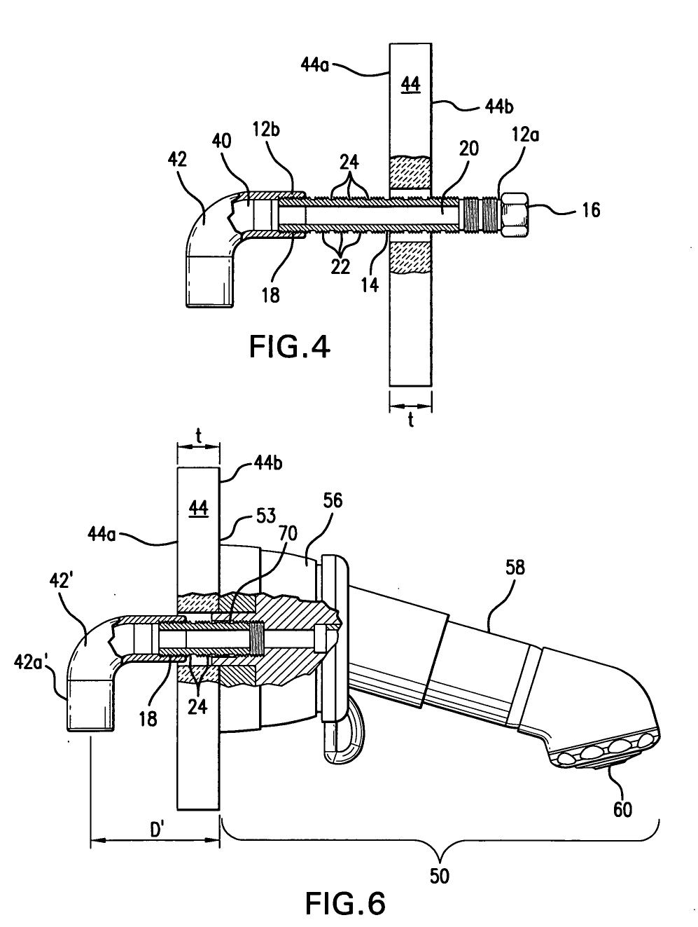

FIGS. 4 through 6 illustrate how the universal nipple of the present invention establishes fluid communication between existing behind-the-wall plumbing and a wall-mounted water delivery device. Referring particularly to FIG. 4, threads 18 of universal nipple 10 engage corresponding threads defined in a fluid passageway 40 of elbow pipe 42. Body 14 of universal nipple 10 extends from elbow pipe 42 through wall 44, said wall having an inner surface 44a, an outer mounting surface 44b and a wall thickness t defined therebetween. It is understood that elbow pipe 42 is merely representative of conventional behind-the-wall plumbing and that multiple behind-the-wall plumbing configurations are contemplated for use with the present invention as is well known in the art. It is also understood that universal nipple 10 may effect engagement with elbow pipe 42 and other behind-the-wall plumbing via other known engagement means.

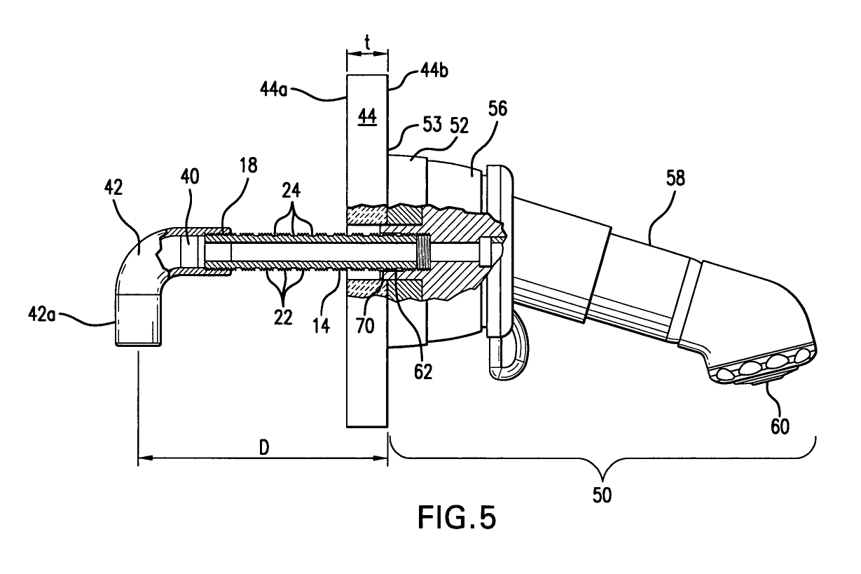

Referring further to FIG. 5, universal nipple 10 is seen supporting a shower fitting 50 thereby. Shower fitting 50 has an escutcheon 52 with a planar mounting surface 53 that is mountable adjacent wall mounting surface 44b. A shower body 56 extends outwardly from escutcheon 52 and supports a spout portion 58 having at least one fluid delivery orifice 60 at a free extent thereof. The method of effecting fluid delivery through shower fitting 50 is well known in the art and forms no part of this invention. It is understood that shower fitting 50 is provided by way of example only and that other shower fitting configurations and other water delivery devices are contemplated for use with the present invention without departing from the scope thereof.

In order to secure shower fitting 50 firmly against mounting surface 44b and simultaneously ensure watertight engagement with elbow pipe 42, the installer measures the installation depth D (here defined as the distance between mounting surface 44b and the longitudinal axis defined through downwardly depending arm portion 42a of elbow pipe 42). It is understood that installation depth D is not limited to the depiction of FIG. 5 and is appropriately measured with respect to the installation requirements of the specific water delivery device or accessory that is being installed. The installer secures universal nipple 10 with elbow pipe 42 (as described hereinabove) so that nipple body 14 traverses wall thickness t and exposes head portion 16 outwardly of mounting surface 44b. The installer determines the number of grooves 24 required to effect optimal securement between threaded regions 22 and corresponding threads 62 defined in shower fitting 50. The installer then truncates the length l of body 14 by severing head portion 16 at the desired groove and secures shower fitting 50 accordingly. It is noted that a sealing member such as O-ring 70 (shown in FIGS. 5 and 6) may be incorporated that easily traverses grooves 24 and threaded regions 22 as shower fitting 50 is arranged thereover. This feature provides the water delivery device with enhanced sealing capability without compromising the ease and effectiveness of the watertight installation. An unobstructed water path is therefore defined from elbow pipe 42 through lumen 20 to orifice 60.

The present invention advantageously facilitates watertight mounting of water delivery devices at various installation depths, as further demonstrated by reference to FIG. 6. Shower fitting 50 is similarly mounted to mounting surface 44b using universal nipple 10 as described hereinabove. An elbow pipe 42′, however, is disposed at a shorter distance relative to inner surface 44a, thereby affecting the extent of an installation depth D′. The installer similarly measures installation depth D′ and truncates nipple body 14 so as to establish an unobstructed water path through lumen 20. The installer severs a larger portion of body 14, yet likewise ensures that remaining threaded portions 22 effectively secure shower fitting 50 to mounting surface 44b. Wall thickness t may vary, and disposition of universal nipple 10 in walls of varying thickness is contemplated.

It is therefore seen that the present invention not only accommodates various water delivery devices, but also permits use of such devices with a plurality of behind-the-wall plumbing configurations. This advantage obviates the need for plural fastening members and further eliminates the need to make adjustments to the location and performance of pre-existing behind-the-wall plumbing. The present achieves these benefits without compromising the aesthetic effect of the water delivery device, thereby enabling the installer with broader design selections.

The present invention is not limited to use with water delivery devices. The present invention is also contemplated for use with sanitary accessories such as towel bars, shelves, toilet tissue holders, tumbler holders and the like. Although such implements do not require watertight fluid communication, it is desirable to provide a universal device that accommodates a plurality of functional and aesthetic goals. The universal nipple of the present invention does not incorporate specialized parts that undesirably increase the cost, time and complexity of manufacture of the device and/or installation of the wall-mountable structure. The present invention may therefore be adapted to such accessories without ameliorating the fluid communication and mounting benefits described hereinabove.

Various changes to the foregoing described and shown structures are now evident to those skilled in the art. The matter set forth in the foregoing description and accompanying drawings is therefore offered by way of illustration only and not as a limitation. Accordingly, the particularly disclosed scope of the invention is set forth in the following claims.

What is claimed is:

1. A universal nipple for securement of a wall-mountable structure to a mounting surface, comprising:
a shank having an elongate body of predefined length terminating in a proximate end and an opposed distal end, said proximate end having an enlarged head portion from which said body depends generally normally and said distal end having means defined thereat for engagement with said mounting surface; said body having a generally circumferential outer surface and an inner surface defining a lumen that is coextensive with said proximate end and said distal end; said internal circumferential surface and said inner surface defining a predefined body thickness therebetween;
wherein said engagement means comprises at least one series of threads defined along said outer circumferential surface with at least one groove there adjacent.

2. The universal nipple of claim 1, wherein said lumen assumes a taper of varying diameter along said predetermined length, said tapered lumen having a first diameter at said proximate end and a second smaller diameter at said distal end such that fluid flows unimpeded through said lumen.

3. The universal nipple of claim 1, wherein said engagement means comprises a plurality of said series of threads having corresponding grooves disposed intermittently therebetween.

4. The universal nipple of claim 1 wherein said head portion has an open area of predetermined diameter defined therewithin, said open area establishing communication with said lumen.

5. The universal nipple of claim 1, further comprising at least one sealing member at or adjacent at least one corresponding groove.

6. The universal nipple of claim 1, wherein said body is truncated at or adjacent at least one of said proximate end and said distal end so as to accommodate engagement of said engagement means with corresponding engagement means defined at or adjacent said mounting surface.

7. A system for effecting securement of a wall-mountable structure to a mounting surface, comprising:
a wall-mountable device;
a universal nipple as provided by claim 1;
wherein engagement of said engagement means of said universal nipple and corresponding engagement means provided on preinstalled support structure located at or adjacent said mounting surface establishes communication between said wall-mountable structure and said support structure.

8. The system according to claim 7, wherein said wall-mountable device is a water delivery device selected from the group of water delivery devices including, but not limited to, showers, bath fillers, faucets and combinations thereof.

9. The system according to claim 8, wherein said engagement between said nipple and said water delivery device establishes fluid communication between said water delivery device and preinstalled plumbing structure at or adjacent said support structure.

10. The system according to claim 7, wherein said nipple body is truncated at or adjacent at least one of said proximate end and said distal end so as to effect said engagement between said nipple and said support structure.
